(19) United States
(12) Patent Application Publication
(10) Pub. No.: US 2009/0147728 A1
(43) Pub. Date: Jun. 11, 2009

(54) Wireless Cooperative Relay Network Transmitting Data using Imperfect CSI

(76) Inventors: George K. Atia, Brighton, MA (US); Andreas F. Molisch, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 11/950,699

(22) Filed: Dec. 5, 2007

(51) Int. Cl. H04B 7/212; H04B 7/185

(52) U.S. Cl. 370/321; 370/316

(57) ABSTRACT

A method, system and network transmit data from a base station, via relay stations, to user stations. Imperfect channel state information (CSI) for downlink channels from the base station and the relay stations to the user stations is acquired. For each candidate transmission strategy of a set of candidate transmission strategies, a corresponding beamforming matrix is determined according the imperfect CSI. For each beamforming matrix, a bound on an expected target benefit function is determined, and a particular one of the bounds is selected. The data are then transmitted from the base station, via the relay stations, to the user stations according to the beamforming matrix associated and the candidate strategy associated with the selected bound.

### FIELD OF THE INVENTION

This invention relates generally to wireless communications networks, and more particularly to transmitting data from a base station to mobile stations via relay stations in a wireless cooperative relay network.

### BACKGROUND OF THE INVENTION

In a wireless network of cooperative nodes (stations); a single node (base station) can transmit data to multiple other nodes (relay stations) and these nodes can then transmit the same data cooperatively to user nodes (mobile stations).

In order to transmit data cooperatively, the transmitting nodes need channel state information (CSI). In the past the assumption has been that the CSI is perfect. In such cases, the total network throughput can be significantly improved when the relay nodes jointly transmit data using optimized linear precoding.

However, with imperfect CSI, it is not clear whether relay cooperation can still provide any benefits. Imperfect CSI has been described in the context of point to point multiple-input/multiple-output (MIMO) channels, as well as MIMO broadcast channel (BC). Conventional models that account for different levels of CSI knowledge include channel mean information (CMI), channel covariance information (CCI), and random vector quantization (RVQ).

It is known that the maximum throughput for MIMO BC can be achieved by dirty paper coding (DPC) at the transmitter. However, that requires perfect CSI at the transmitter. However, acquiring the perfect CSI is impractical with fast varying channels, multiuser scenarios, mobile stations, let alone the complexity of that strategy. Therefore, it is desired to transmit optimally in a wireless cooperative relay network based on imperfect CSI.

In the following, to give a concrete example of a practical network, relay cooperation in WiMAX networks (Worldwide Interoperability for Microwave Access) is described. WiMAX is based on the IEEE 802.16e standard. As an alternative to wired broadband like cable and DSL, WiMAX is intended to provide high-speed broadband communication via a wireless channel. The radius of a typical WiMAX cell is expected to be about: three to ten kilometers, with a deliver capacity of up to 40 Mbps per channel. WiMAX uses orthogonal frequency division multiplexing (OFDM).

### SUMMARY OF THE INVENTION

The embodiments of the invention provide a wireless cooperative relay network where data are transmitted optimally using imperfect channel state information (CSI) in the downlink of the wireless channels.

Data intended for user nodes are transmitted from a base station. The data are received at relay nodes. The relay nodes decode the received data fully or partially, depending on the transmission bit rate and the quality of the corresponding wireless channels. The relay nodes cooperate by jointly beamforming the data to multiple other nodes given only statistics of the channels, i.e., channel distribution information (CDIT).

The embodiments of the invention consider a channel mean feedback model, also known as channel mean information (CMI), in which only the channel mean and covariance are available at the transmitter.

It is the objective to optimize the network performance based on a target benefit function, which takes into consideration transmit bit rates, cooperation architecture and beamforming transmit vectors of a set of candidate transmission strategies for the base station and the relay nodes.

The embodiments also provide an adaptive beamforming method that maximizes an upper bound on a total mean network throughput as the target benefit function in one embodiment. Even though the relay nodes have imperfect CSI, this type of relay cooperation can significantly improve the total network throughput.

For both symmetric and asymmetric knowledge, a class of zero forcing (ZF) and minimum mean square error (MMSE) beamforming strategies are provided.

### BRIEF DESCRIPTION OF THE DRAWINGS

FIG. 1 is a schematic of a wireless cooperative relay network according to an embodiment of the invention; and

FIG. 2 is a flow diagram of a method for transmitting optimally data according to an embodiment of the invention.

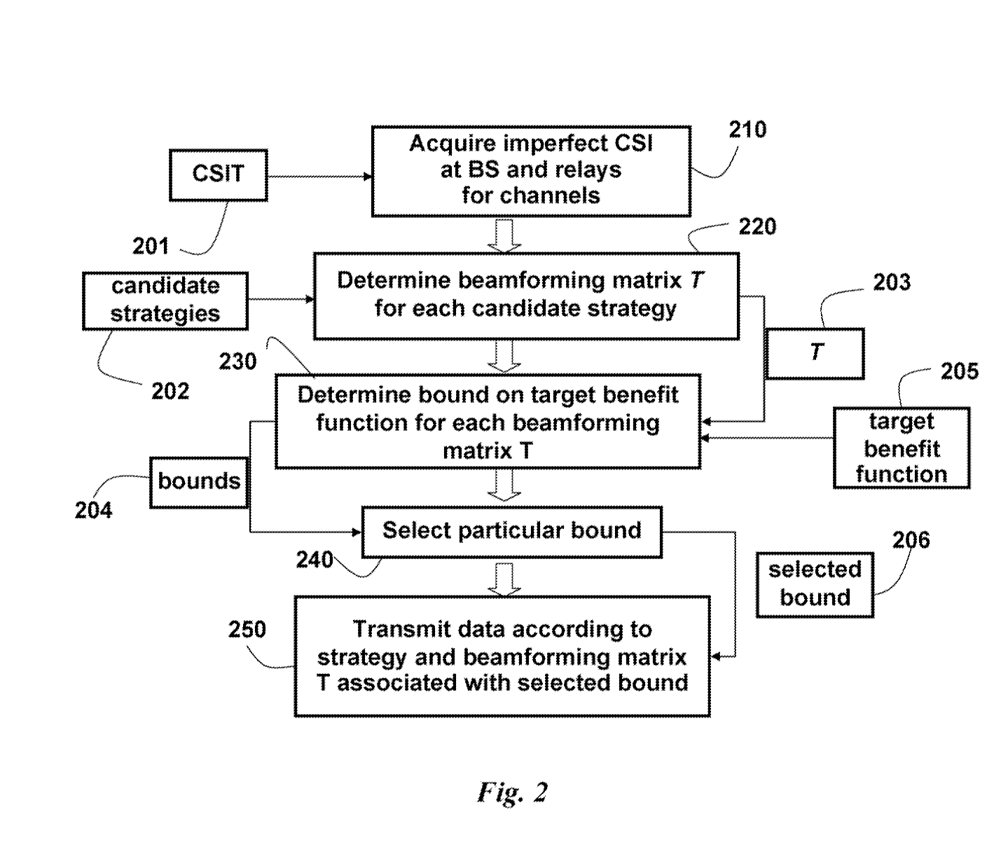

### DETAILED DESCRIPTION OF THE PREFERRED EMBODIMENTS

Cooperative Relay Network

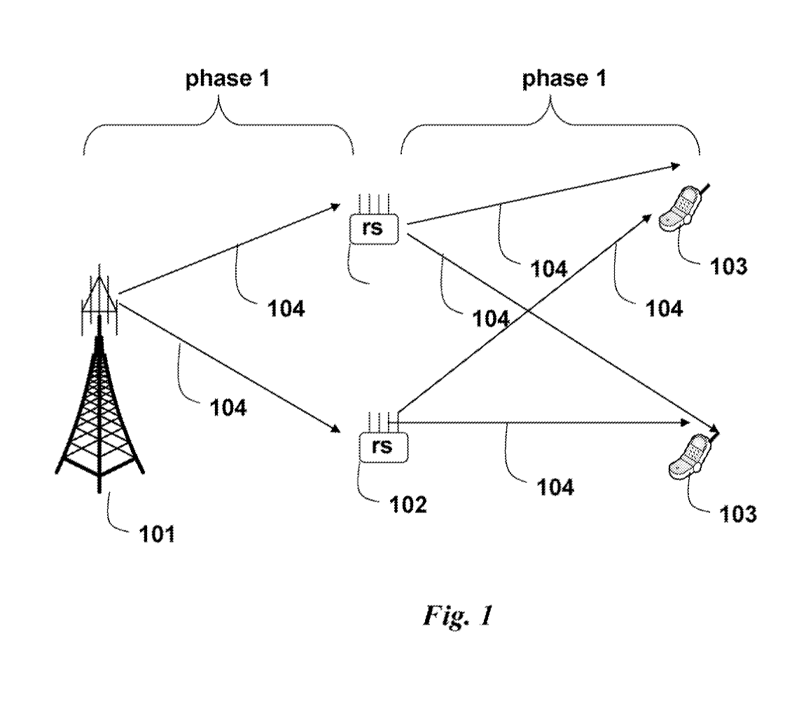

FIG. 1 shows a wireless cooperative relay network of nodes (stations) according to an embodiment of our invention. In a preferred embodiment, the network is designed according to the WiMAX standard. However, it should be understood, that the embodiments of the invention can be used with other types of cooperative relay networks.

The network includes at least one base station (BS) 101, one or more relay nodes 102, and user nodes 103, e.g., mobile stations. The nodes communicate via wireless channels. Each channel includes a downlink and an uplink. The invention is particularly concerned with the downlink channels 104 from the base station to the relays, and from the relays to the mobile stations.

For simplicity of this description and as shown in FIG. 1, we assume a single base station, two relay stations and two mobile stations. We also assume the transmitters and receivers each, have one antenna. Extending this architecture to networks with a larger number of nodes, and multiple antennas at each node is straightforward.

The embodiments of our invention provide a method for relaying data in the cooperative relay network using the wireless channels between the nodes. Our relay cooperation is performed with imperfect channel state information (CSI) in the downlink of the wireless channels 104.

Relaying Data

Data intended for different relay nodes 102 are transmitted from the base station 101 and received at the relay stations (RS) 102 during phase 1. The relay stations decode the received data fully or partially. The partial decoding can be due to the fact that not all relays decode all users' messages. The decoding, in part, depends on the transmission bit rate and the quality of the corresponding wireless channels. The relay stations cooperate by jointly beamforming the data to multiple other nodes 103 during phase 2. The relays have imperfect CSI in the form of channel statistics, i.e., channel distribution information (CDIT).

Channel Matrices

A channel matrix between the base station and the relay nodes is G. The channel matrix G is usually associated with a slow varying channel because the base station and the relay nodes are usually stationary. Thus, the channel matrix G is perfectly known at the base station. The relay nodes receive data intended to different users according to a channel matrix G known at the base station. The data are decoded by the relay nodes. If only some of the relay nodes decode the data, then the decoding is partial.

Decoded data are then retransmitted to multiple users 103 through joint linear beamforming from the relay nodes according to a channel matrix H determined at the relay nodes.

The channel matrix between the relay nodes and the example two user nodes is H=[h₁, h₂], where hᵢ denotes the channel vector from the relay nodes to the i^{th} user node. Due to mobility of the user nodes and channel fluctuations, the channel matrix H is not fully available (imperfect) at the relay nodes or the base station, and only statistics, i.e., mean and covariance information are present. It should be noted that our assumption that only mean and covariance are known covers situations where the CSI is affected by noise and quantization errors, the CSI is outdated, or only the average CSI (averaged over the fading) is known.

The received signal yᵢ at user node i is

yᵢ=hᵢ^{T}x+n (1)

where T is a transpose operator, x is the transmitted signal, and n is unit variance complex circularly symmetric additive white Gaussian noise (AWG-N), i.e., n˜CN(0, 1).

We apply linear preceding to the data to be transmitted at the relay nodes so that the transmitted signal is

x=ΣᵢTᵢbᵢ,

where T represents the beamforming matrix, and b, the transmitted data for user i.

The transmitted signal x satisfies a total power constraint P. Thus, P=tr(TT^{H}), where T is the beamforming matrix T=[T₁ T₂]. We assume perfect CSI at the receiving nodes (CSIR).

The channel matrix at the transmitter is modeled as

H= H̅+H_{W}, (2)

where H_{W} has a complex Gaussian distribution with a zero mean and covariance R, i.e., H_{W}˜CN(0, R). Hence, H˜CN( H̅, R), where H̅ and R are the channel mean and covariance matrices, respectively. Unless stated otherwise, we use R=αI. This model can account for various situations, e.g., Ricean link, and limited feedback with MMSE estimation at the transmitter.

Transmission Bit\Rate and Throughput

The transmitted bit rate to user k in the j^{th} transmission phase j is Rₖ^{(j)}, e.g., during phase 1 from the BS to the relay nodes, and during phase 2 from the relay nodes to the user nodes.

Thus, if nₖ represents the total bits transmitted to the k^{th} user, then the total network throughput, defined as a ratio of the total transmitted bits to the total time for the transmission, is

$$Throughput = \frac{{n}_{1} + {n}_{2}}{\frac{{n}_{1}}{{R}_{1}^{( 1 )}} + \frac{{n}_{2}}{{R}_{2}^{( 1 )}} + max \{ \frac{{n}_{1}}{log ( 1 + {γ}_{1} )} , \frac{{n}_{2}}{log ( 1 + {γ}_{2} )} \}} \qquad ( 3 )$$

where γₖ represents the receive signal to noise ratio (SNR) at user k during phase 2. The SNR depends on the transmission method, and hence on the transmit beamforming matrix.

Because the channel matrix H is not fully known, i.e., imperfect, at the transmitting nodes (base station and relay nodes), our object is to maximize the expected network throughput, subject to power constraints at the base station and relay nodes, where the expectation is taken with respect to the randomness in the channel matrix H, conditioned on the available channel statistics, i.e., the CDIT.

We note that the total throughput: is one possible target benefit function that is used herein as an example. Other possible target benefit functions include total energy consumption, amount of inter-cell interference generated. Linear or non-linear combinations of the above-mentioned benefit functions are also possible.

Transmission Strategies

A number of candidate transmission strategies are possible, including: single user messaging in the case the base station or relay station selects to transmit data to only one user node; and dual messaging in the case the data are transmitted concurrently to multiple user nodes.

In case of the dual user messaging, time division multiple access (TDMA) is applied during phase 1, followed by joint beamforming from the relay nodes to the user nodes during phase 2, Note that asymmetry of message knowledge at the relay nodes, even though suboptimal during phase 2 as described below, can possibly lead to throughput gains because symmetric knowledge can require more transmission time and energy depending on the joint quality of the channel matrices G and H, as well as the quality of the CSIT, thus affecting the total network throughput.

Maximizing Network Throughput

The set of preceding vectors T includes symmetric/asymmetric ZF/MMSE and single messaging beamforming vectors. We also derive beamforming vectors for various cooperation architectures. Hence the problem is to optimize a target benefit function e.g., maximize the expected total network throughput E[th], where the maximization is for an optimal selection of nₖ, R^{(j)}, and the transmission architecture, e.g., single versus dual messaging, and symmetric versus asymmetric message knowledge.

Due to non convexity, the above optimization, max E[th], is difficult to solve. We can either solve the optimization numerically or find analytically approximations or bounds, which are then optimized. To exemplify our approach, in the following we describe a method that maximizes an upper bound on the total mean network throughput.

Optimization Objectives and Strategies

In one embodiment the target benefit function maximizes an upper bound on the total mean network throughput for WiMAX networks under a CMI assumption, where the BS transmits to the relay nodes during phase 1, and the relays transmit to the user nodes during phase 2, with imperfect CSI at the transmitting nodes (BS and relays), i.e., with only channel mean and covariance information.

We maximize an upper bound on the sum rate of transmission during phase 2 from the relay nodes to the mobile users for various linear preceding schemes.

We provide an adaptive beamforming cooperative method that optimizes the network throughput with imperfect CSI at the transmitters. The method maximizes the upper bound on the total mean throughput by optimally selecting transmission rates, cooperation architecture and transmit beamforming vectors. Our method leads to significant gains compared to conventional non cooperative/non adaptive strategies. Asymmetric cooperation can maximize throughput even with imperfect CSI.

We provide partial zero forcing and MMSE beamforming filters for the asymmetric cooperation architecture for both perfect and imperfect CSI cases.

We provide candidate beamforming strategies for the CMI case.

Transmission Method

FIG. 1 shows the method for transmitting data from the base station, via the relay stations, to the user stations according to an embodiment of our invention. The method is according to the above optimization objectives and strategies. Each step is described in greater detail below.

The base station and the relay stations acquire 210 imperfect channel state information (CSIT) 201 for the channels from the base station and the relay stations to the user stations. The CSIT 201 can be acquired from CSI feedback from the user stations, or from signals previously received form the user stations, assuming channel reciprocity. The CSIT can also be based on a historical record of the CSI.

For each strategy of a set of candidate transmission strategies 202, we determine 220 a corresponding beamforming matrix T 203.

A bound or approximation 204 is determined 230 on a target benefit function 205 for each beamforming matrix 203. The bounds can be upper, lower or approximate. Possible target benefit functions are described in greater detail below.

From the bounds 204, a particular one of the bounds 206 is selected 206. The manner in which the bound is selected is described in greater detail below.

Then, data are transmitted 250 according to the corresponding beamforming matrix and candidate strategy associated with the optimal upper bound 206.

Upper Bound Based Adaptive Beamforming

In this section, the target benefit function maximizes the upper bound on the total network throughput. We optimally select the parameters of the candidate transmission strategies, i.e., bit rates, number of bits, architectures, which maximize the upper bound on the total expected network throughput. This can significantly improve the total network throughput, even with the imperfect CSI.

Upper Bound on Total Mean Network Throughput

Conditioned on the channel mean matrix H̅ and a covariance matrix R available at the transmitting nodes (BS and relay nodes), the expected sum rate during phase 2 is

$$E [ {R}^{( 2 )} ] = {\sum }_{i = 1}^{K} E [ {R}_{k}^{( 2 )} ] = {\sum }_{k} E [ log ( 1 + \frac{{\vert {h}_{k}^{H} {T}_{k} ( \overline{H} , R ) \vert}^{2}}{1 + {\sum }_{j \neq k}^{ } {\vert {h}_{k}^{H} {T}_{j} ( \overline{H} , R ) \vert}^{2}} ) / \overline{H} , R ] \qquad ( 4 )$$

where K is the total number of users, for simplicity K=2. To simplify notation, we drop the conditioning as it can be well understood from the context of this description.

The expected bit rate Rₖ can be simplified to

$${R}_{k} = E [ log ( 1 + {\vert {h}_{k}^{H} {T}_{k} ( \overline{H} , R ) \vert}^{2} + {\sum }_{j \neq k} {\vert {h}_{k}^{H} {T}_{j} ( \overline{H} , R ) \vert}^{2} ) - log ( 1 + {\sum }_{j \neq k } {\vert {h}_{k}^{H} {T}_{j} ( \overline{H} , R ) \vert}^{2} ) ] \qquad ( 5 )$$

Because the above problem is neither convex nor concave, the base station optimizes an upper bound on the total network: throughput as described below.

If we define x=n₁/n₂, then for a given value of x, the expected throughput is a multivalued function

$$E [ Thgpt ] = \{ \begin{matrix}{f}_{1} ( {R}_{1}^{( 2 )} ) = E [ \frac{x + 1}{α x + β + \frac{x}{{R}_{1}^{( 2 )}}} ] & x > \frac{{R}_{1}^{( 2 )}}{{R}_{2}^{( 2 )}} \\ {f}_{2} ( {R}_{2}^{( 2 )} ) = E [ \frac{x + 1}{α x + β + \frac{1}{{R}_{2}^{( 2 )}}} ] & otherwise\end{matrix} \qquad ( 6 )$$

with α and β representing respectively the transmit rates of data for user 1 and data for user 2 during phase 1. α and β take values from {0, C_{BR}_{₁}, C_{BR}_{₂}}, where C_{BR}, denotes the capacity of channel between the BS and relay i.

Using the smoothing property of expectations, the expected throughput function (6) can be written as a convex combination of concave functions. Dropping the prefix (2) to simplify notation, the expected throughput for the signal x is

$$E [ thgpt ] = Pr [ {R}_{1} \leq x \cdot {R}_{2} ] \cdot E [ {f}_{1} ( {R}_{1} ) ] + Pr [ {R}_{1} > x \cdot {R}_{2} ] \cdot E [ {f}_{2} ( {R}_{2} ) ] \leq Pr [ {R}_{1} \leq x \cdot {R}_{2} ] \cdot \frac{x + 1}{α x + β + E [ \frac{x}{{R}_{1}} ]} + Pr [ {R}_{1} > x \cdot {R}_{2} ] \cdot \frac{x + 1}{α x + β + E [ \frac{1}{{R}_{2}} ]} \leq Pr [ {R}_{1} \leq x \cdot {R}_{2} ] \cdot \frac{x + 1}{α x + β + \frac{x}{E ( {R}_{1}^{( 2 )} )}} + Pr [ {R}_{1} > x \cdot {R}_{2} ] \cdot \frac{x + 1}{α x + β + \frac{1}{E [ {R}_{2}^{( 2 )} ]}} \leq \frac{x + 1}{α x + β + min \{ \frac{x}{E [ {R}_{1}^{( 2 )} ]} , \frac{1}{E [ {R}_{2}^{( 2 )} ]} \}} \qquad ( 7 )$$

We further refine the upper bound for different cases and regions,

$$Case 1 : \frac{{R}_{1}}{{R}_{2}} \leq \frac{E [ {R}_{1} ]}{E [ {R}_{2} ]}$$

In this case, we consider the following regions;

$$region 1 \text{:} x ∈ ( 0 , \frac{{R}_{1}}{{R}_{2}} ) :$$

In this region, the confirmed bound is

$$\frac{x + 1}{α x + β + \frac{1}{E [ {R}_{2}^{( 2 )} ]}} ,$$

which can be written as

$$\frac{x + 1}{α x + β + max \{ \frac{x}{E [ {R}_{1}^{( 2 )} ]} , \frac{1}{E [ {R}_{2}^{( 2 )} ]} \}} since x < \frac{E [ {R}_{1} ]}{E [ {R}_{2} ]} . \\ region 2 \text{:} x ∈ ( \frac{{R}_{1}}{{R}_{2}} , \frac{E [ {R}_{1} ]}{E [ {R}_{2} ]} ) :$$

The confirmed upperbound in this region can be refined by a tighter upper bound. The expression of the expected total throughput,

$$max \{ \frac{x}{{R}_{1}} , \frac{1}{{R}_{2}} \}$$

can be replaced by the minimum, which leads to an upper bound on the total throughput. In this case,

$$min \{ \frac{x}{{R}_{1}} , \frac{1}{{R}_{2}} \} = \frac{1}{{R}_{2}} .$$

Now, using Jensen's inequality, this leads to a bound on the throughput

$$\frac{x + 1}{α x + β + \frac{1}{E [ {R}_{2}^{( 2 )} ]}} ,$$

which can be written as

$$\frac{x + 1}{α x + β + max \{ \frac{x}{E [ {R}_{1}^{( 2 )} ]} , \frac{1}{E [ {R}_{2}^{( 2 )} ]} \}} since x < \frac{E [ {R}_{1} ]}{E [ {R}_{2} ]} .$$

$$Region 3 \text{:} x ∈ ( \frac{E [ {R}_{1} ]}{E [ {R}_{2} ]} , ∞ ) :$$

In this region it easy to verify that the confirmed bound is again equal to

$$\frac{x + 1}{α x + β + max \{ \frac{x}{E [ {R}_{1}^{( 2 )} ]} , \frac{1}{E [ {R}_{2}^{( 2 )} ]} \}} .$$

$$Case 2 \text{:} \frac{{R}_{1}}{{R}_{2}} > \frac{E [ {R}_{1} ]}{E [ {R}_{2} ]}$$

Again the refinement is in the region

$$x ∈ ( \frac{E [ {R}_{1} ]}{E [ {R}_{2} ]} , \frac{{R}_{1}}{{R}_{2}} ) .$$

In the throughput expression, we can replace the max with the min and still obtain an upper bound. Now, in the aforementioned region,

$$min \{ \frac{x}{{R}_{1}} , \frac{1}{{R}_{2}} \} = \frac{x}{{R}_{1}} ,$$

which would lead to a bound 1 because

$$x > \frac{E [ {R}_{1} ]}{E [ {R}_{2} ]} .$$

The other two regions for the second case can be similarly confirmed.

If the target benefit function is total throughput, then an upper bound can be expressed as

$$E [ Thgpt ] \leq \frac{x + 1}{α x + β + max \{ \frac{x}{E [ {R}_{1}^{( 2 )} ]} , \frac{1}{E [ {R}_{2}^{( 2 )} ]} \}} , ∀ x \qquad ( 8 )$$

The above function is concave or convex over the intervals [0, x*], [x*, ∞], with x* defined as the ratio of the expected values

$${x}^{*} = \frac{E [ {R}_{1}^{( 2 )} ]}{E [ {R}_{2}^{( 2 )} ]} ,$$

then the value to be tested are 0, ∞, and x.

Our method can be summarized as follows.

Given the feedback of the channel statistics, the base station optimizes a derived upper bound on an expected throughput by optimizing over a candidate T from a finite set of T, (symmetric/asymmetric MMSE/ZF) with

$$x = \frac{E [ {R}_{1}^{( 2 )} ]}{E [ {R}_{2}^{( 2 )} ]}$$

for dual messaging and x=0 or ∞ for single user messaging.

The beamforming vectors are as derived in the next section. Note that we also replace exact values of the expected throughputs of phase 2 with corresponding upper bounds in terms of the mean and covariance, which again leads to the upper bound on the expected network throughput.

Upper Bound on Sum Rate During Phase 2

The first term in the RES of Equation (5) can be bounded using Jensen's inequality as

$$Term 1 \leq log ( 1 + {T}_{k}^{H} ( \overline{{h}_{k}} \overline{{h}_{k}} + R ) {T}_{k} + {\sum }_{j \neq k} {T}_{j}^{H} ( \overline{{h}_{k}} \overline{{h}_{k}} + R ) {T}_{j} ) . \qquad ( 9 )$$

Jensen's inequality relates the value of a convex function of an integral to the integral of the convex function.

Next, we derive a lower bound on the second logarithmic term:

$$Term 2 = E [ log ( 1 + {\sum }_{j \neq k} {\vert {h}_{k} {T}_{j} \vert}^{2} ) ] = E [ log ( 1 + y ) ] \qquad ( 10 )$$

Using Markov inequality,

$$E [ log ( 1 + y ) ] \geq {max}_{a , a \geq 0} a \cdot Pr [ y \geq {2}^{a} - 1 ] = {max}_{a , a \geq 0} a [ 1 - {F}_{y} ( {2}^{a} - 1 ) ] \qquad ( 11 )$$

It can easily be show that the received signal y is the sum of non central χ²(2) random vectors with non centrality parameter

$${s}_{j}^{2} = {\vert \overline{{h}_{k}} {T}_{j} \vert}^{2} , \qquad ( 12 )$$

where the variance of the Gaussian distribution generating random vectors is

$${σ}^{2} = \frac{1}{2} {T}_{j}^{H} {T}_{j ,} \\ that is \\ σ = \sqrt{\frac{1}{2} tr ( {T}_{j} {T}_{j}^{H} )} , \qquad ( 13 )$$

which in case of equal power beamforming is

$$σ = \sqrt{\frac{P}{2 M}} . \qquad ( 14 )$$

For the case where K=2, the distribution of the received signal y is chi-squared with two degrees of freedom, χ²(2), i.e.,

$${f}_{Y} ( y ) = \frac{1}{2 {σ}^{2}} {e}^{- \frac{{x}^{2} + y}{2 {σ}^{2}}} {I}_{0} ( \sqrt{y} \frac{8}{{σ}^{2}} ) ,$$

where I₀(.) is a modified 0^{th} order Bessel function of the first kind. Hence, the cumulative distribution function of the received signal y is

$${F}_{Y} ( y ) = 1 - {Q}_{1} ( \frac{8}{σ} , \frac{\sqrt{y}}{σ} )$$

where Q₁(.,.) is the generalized Marcum Q function, which is given by

$${Q}_{1} ( α , β ) = {e}^{- \frac{{α}^{2} + {β}^{2}}{2}} {\sum }_{k = 0}^{∞} {I}_{k} ( α β ) . \qquad ( 15 )$$

The Marcum Q function is frequently used in performance analysis of partially coherent, differentially coherent, and noncoherent communications, Cantrell, P. E. and Ojha, A. K. “Comparison of Generalized Q-Function Algorithms,” IEEE Trans. Info. Th. 33, 591-596, July 1987.

If the target benefit function is the sum rate, then we can also lower bound the second logarithmic term in Equation (5) as

$$E [ log ( 1 + y ) ] \geq {max}_{a , a > 0} a [ {Q}_{1} ( \frac{\vert {\overline{h}}_{k}^{H} {T}_{j} \vert}{\sqrt{\frac{1}{2} tr ( {T}_{j} {T}_{j}^{H} )}} , \frac{\sqrt{{2}^{a} - 1}}{\sqrt{\frac{1}{2} tr ( {T}_{j} {T}_{j}^{H} )}} ) ] , \qquad ( 16 )$$

One can solve for a numerically, or alternatively, we determine the lower bound on the above target benefit function using the known bound on the Marcum function

$$E [ log ( 1 + y ) ] \geq {max}_{a , a > 0} a \cdot {Q}_{1} ( α , β ) \geq {max}_{a} a \cdot {e}^{- \frac{{( α + β )}^{2}}{2}} if β > α \geq 0 \geq {max}_{a} a \{ 1 - \frac{1}{2} [ {e}^{- \frac{{( α + β )}^{2}}{2}} - {e}^{- \frac{{( α + β )}^{2}}{2}} ] \} if α > β \qquad ( 17 )$$

Beamforming Strategies during Phase 2

In this section we describe our beamforming strategies. We describe symmetric and asymmetric linear preceding techniques that satisfy different performance criterion such as partial/full ZF (interference cancellation) and MMSE beamforming.

Zero Forcing Strategies

In case of dual messaging, we assume the relay nodes can fully cooperate and we also assume synchronization. If messages for all users are received symmetrically at the relay nodes, then we are in a MIMO BC situation.

Partial Zero Forcing Beamforming PZF for the Asymmetric Case with Full CSIT and CMI

In an asymmetric situation, one entry of a beamforming vector is forced to zero to account for asymmetric message knowledge at the relay nodes. We provide partial ZF beamforming (PZF) by selecting one of the beamforming vectors orthogonal to channel vector, or its estimate in case of imperfect CSI, then, we optimize for the non-zero entry of the other beamforming vector to maximize the sum rate.

We also consider the sum rate for the case with no cooperation among relay nodes.

Without loss of generality, assume relay 1 has a message for both users whereas relay 2 has only one message intended to user 2.

Let T_{ZF}=Φ=[φ₁, φ₂]. In case of perfect CSIT, PZF works as follows. First, select φ₂, the transmit vector for stream 2, such that φ₂ ⊥ h₁. Second, select φ₁ such that for every channel realization:

$$\begin{matrix}{φ}_{11} = arg {max}_{{φ}_{11}} {R}_{sum} ( {φ}_{11} ) \\ = arg max [ log ( 1 + \frac{P}{2} {\vert {h}_{11} {φ}_{11} \vert}^{2} ) + log ( 1 + \frac{\frac{P}{2} {\vert {h}_{2}^{T} {φ}_{2} \vert}^{2}}{1 + \frac{P}{2} {\vert {h}_{12} {φ}_{11} \vert}^{2}} ) ]\end{matrix} \qquad ( 18 )$$

The same idea for the imperfect CSI case with CMI can he used. However, this time change the true channel realizations with estimates. In this case, we maximize the expected the sum rate.

Transmission with only CMI
Select φ₂ ⊥ ĥ₁, and normalize.
Select such that

Now select φ₁₁ such that

$${φ}_{11} = arg {max}_{{φ}_{11}} {E}_{H} [ {R}_{sum} / {H}_{FB} ]$$

where H˜N( H̅, αI).

Then the achievable sum rate is

E_{θ}E_{H/θ}[Rₛᵤₘ],

where θ characterizes the distribution of H under the mean feedback model.

Another method assumes that the channel is equal to its estimate when doing the optimization and selects φ₁₁ to maximize the sum rate, with H replaced by its estimate.

MMSE Beamforming

The object is to minimize the sum of the MSB between the transmitted and received signals.

Optimization Problem

arg min E[∥s−HTs∥^{2]} s.t.∥T∥_{F}²≦P, T_{B}=0, (20)

where ∥.∥_{F} denotes the Frobenius norm, and T_{B} denotes the block or entry from the beamforming matrix T that has to be forced to zero to account for asymmetric message knowledge. The following describes solving the optimization problem for both, the symmetric and the asymmetric cases. It is known that the solution for the symmetric case leads to

$${T}_{k} = {( {\sum }_{i = 1}^{K} {H}_{i}^{H} {H}_{i} + {λ}_{1} I )}^{- 1} {H}_{k}^{H} , \qquad ( 21 )$$

where Tₖ is the beamforming vector for the k^{th} user stream, and Hₖ is a row vector 1×M for the k^{th} user channel. λ₁ is selected to satisfy the total power constraint. Thus,

$$P = {\sum }_{j = 1}^{M} \frac{{γ}_{j}}{{( {γ}_{j} + {λ}_{1} )}^{2}} ,$$

where γⱼ are the eigenvalues of the Hermitian matrix

A=Σᵢ₌₁^{K}Hᵢ^{H}Hᵢ.

To extend this analysis to the asymmetric case, we add a constraint that forces some of the entries of some of the vectors to zero. We partition the beamforming vectors into two categories. Category 1 of size n corresponds to the full beamforming vectors that correspond to the user nodes that receive data from all the relay nodes, i.e., the decoding is full. Category 2 is for the users that only receive from some of relays because not all the relays have decoded all the users' messages, i.e., the decoding is partial.

Thus, the optimization problem area becomes;

$${min}_{{T}_{j} , j = 1 : K} {\sum }_{j = 1}^{K} {MSE}_{j} \\ s . t . tr ( {\sum }_{i = 1}^{K} {T}_{i}^{H} {T}_{i} ) = P \\ and \\ {e}_{l} {T}_{j} = 0 ; l ∈ S , j = n + 1 … K , \qquad ( 22 )$$

where eⱼ is a binary vector with ones at the entries to be nulled from Tⱼ, because the l^{th} relay does not have a message to the j^{th} user. For simplicity, we assume that whenever this situation arises l is only one index, i.e., only one relay does not have a message, i.e., |S|=1. We form the Lagrangian as

$$= {\sum }_{j = i}^{K} tr ( {H}_{j} ( {\sum }_{i = 1}^{K} {T}_{i} {T}_{i}^{H} ) {H}_{j}^{H} + {N}_{0} I - {T}_{j}^{H} {H}_{j}^{H} - {H}_{j} {T}_{j} + I ) + {λ}_{1} ( tr ( {\sum }_{i = 1} {T}_{i} {T}_{i}^{H} ) - P ) + {\sum }_{j = n + 1}^{K} Re [ {λ}_{j}^{*} {e}_{l}^{T} {T}_{j} ] . \qquad ( 23 )$$

Taking the derivative with respect to T*ⱼ, we obtain the adjoint equation

$$\frac{\partial }{\partial {T}_{j}^{*}} = \frac{\partial F}{\partial {T}_{j}^{*}} + {\sum }_{j = n + 1}^{K} \frac{\partial }{\partial {T}_{j}^{*}} Re [ {λ}_{j}^{*} {e}_{l}^{T} {T}_{j} ] \qquad ( 24 )$$

The first category remains unchanged, whereas the second category becomes

$${T}_{j} = {( {\sum }_{i = 1}^{K} {H}_{i}^{H} {H}_{i} + {λ}_{1} I )}^{- 1} ( {H}_{j}^{H} - {λ}_{j}^{*} e ) . \qquad ( 25 )$$

We solve for the Lagrangian multipliers to satisfy the constraints. We start with the multipliers corresponding to the zero forcing constraints

A=Σᵢ₌₁^{K}Hᵢ^{H}Hᵢ.

Note that A is a Hermitian matrix. We use Bₗ to denote the l^{th} row of a matrix B.

Then, because the l^{th} entry of the vector Tⱼ has to be zero

(A+λ₁I)ₗ⁻¹(Hⱼ^{H}+λⱼe)=0 (26)

From this equation it is easy to see that, the Lagrange multiplier corresponding to the j^{th} transmit vector satisfies

$${λ}_{j} = - \frac{{( A + {λ}_{1} I )}_{l}^{- 1} {H}_{j}^{H}}{{( A + {λ}_{1} I )}_{l , l}^{- 1}} . \qquad ( 27 )$$

Note that l is different for each Tⱼ. Tat is l=l(j). Now λ₁ is selected to satisfy the sum power constraint P. That is,

$$tr ( {( A + {λ}_{1} I )}^{- 1} {A ( A + {λ}_{1} I )}^{- 1} ) + {\sum }_{j} {λ}_{j}^{2} tr ( {( A + {λ}_{1} I )}^{- 1} {e}_{l} {{e}_{l}^{T} ( A + {λ}_{1} I )}^{- 1} ) = P \qquad ( 28 )$$

Thus,

$${\sum }_{m} \frac{{γ}_{m}}{{( {λ}_{1} + {γ}_{m} )}^{2}} + {\sum }_{j} {\sum }_{m} {( \frac{{λ}_{j}}{{γ}_{m} + {λ}_{1}} )}^{2} {( {U}_{m} {U}_{m}^{- 1} )}_{l ( j ) , l ( j )} = P \\ {\sum }_{m} \frac{{γ}_{m}}{{( {λ}_{1} + {γ}_{m} )}^{2}} + {\sum }_{j} {\sum }_{m} {( \frac{{λ}_{j}}{{γ}_{m} + {λ}_{1}} )}^{2} {\vert {U}_{m} ( l ) \vert}^{2} = P \qquad ( 29 )$$

where γₘ are the eigenvalues of the matrix A, and U its single value decomposition, eigenvectors. Note that l is a function of j, and that U is unitary, and

A=UDU^{H}=UDU¹ because the matrix A is Hermitian. We solve for λ₁ numerically by replacing for λⱼ.

Now, we describe the imperfect CSI with the asymmetric MMSE and examine the optimized MMSE where λ₁ is optimal. By taking second derivative of the power constraint with respect to λ₁, we show that the function is locally convex. The function is convex between the eigenvalues of the matrix A, and the poles of the Lagrange multipliers λⱼ. More specifically, we define the set of point aⱼ as the poles of λ. For simplicity, we consider the case of 2×2 antenna system

$${a}_{j} = - \frac{{γ}_{1} {\vert {U}_{2} ( 2 ) \vert}^{2} - {γ}_{2} {\vert {U}_{1} ( 2 ) \vert}^{2}}{{\vert {U}_{1} ( 2 ) \vert}^{2} + {\vert {U}_{2} ( 2 ) \vert}^{2}} \qquad ( 30 )$$

The constraint function is convex over the intervals

(−∞, γ₁) . . . (−γᵢ₋₁, −γ₄), (−γᵢ, αⱼ) . . . (−γ_{M}, ∞).

Thus, we solve for the solutions numerically because the number of local minima is bounded, and obtain the solution that leads to the smallest MSE, which is defined below as a function of the generated transmit vectors. When we operate in the HSNR regime, the gains from optimal power control are diminishing. Note that this optimization leads to a better MSE but not necessarily to a better sum rate

$$MSE = {\sum }_{j = 1}^{K} tr ( {H}_{j}^{T} ( {\sum }_{i = 1}^{K} {T}_{i} {T}_{i}^{H} ) {H}_{j}^{*} + {N}_{o} - {T}_{j}^{H} {H}_{j}^{*} - {H}_{j}^{T} {T}_{j} + I ) \qquad ( 31 )$$

We also obtain the asymmetric Wiener filter. The Wiener filter is equivalent to an SINR maximizer in case of symmetric transmission. We solve the scaled version of the MMSE minimization problem below

T=arg min E[∥b−β⁻¹ŝ∥²] s.t. P, eT=0, (32)

which leads to the following vectors:

Category 1 (Normal)

Tⱼ=β(A+α₁I)Hⱼ, (33)

Category 2 (Zero Forced)

Tj=β(A+α₁I)(Hⱼ−αⱼe). (34)

where αⱼ=λⱼB.

The value β is selected to satisfy the power constraint. Hence, it can be written as a function of α₁ and α₂. α₂ is selected as before to satisfy the asymmetry constraint. Thus, it remains to differentiate the Lagrangian with respect to α₁ to obtain the optimal filters.

Because we satisfy the constraints with the choices of β and αⱼ, the optimal α₁ can be obtained by minimizing the unconstrained optimization problem, i.e.

α₁=arg min−tr(H(H^{H}H+α₁I)⁻¹(H+α₂)(α₁)J₂₁))−tr((H+α*₂J₂₁^{T})(H^{H}H+α₁I)⁻¹H^{H})+tr(H^{H}H+α₁I)⁻²(H^{H}+α₂J₂₁)(H^{H}+α₂J₂₁)(H+α*₂J₂₁^{T})H^{H}H)+Kβ⁻²(α₁), (35)

which can be solved for numerically.

MMSE Beamforming for CMI

min E_{H}[MSE] s.t. tr(T^{H}T)=P (and) eₗTⱼ=0 ∀ l ε S if S≠Φ, (36)

with H˜N( H̅, Rᵣ), i.e., Hⱼ= H̅ⱼ+H_{W}Rₜ^{1/2} with H_{W}˜N(0, σ²I).

The expected MSE for the j^{th} user can be written as:

$$MSE = tr ( {\overline{H}}_{j} ( {\sum }_{i = 1}^{K} {T}_{i} {T}_{i}^{H} ) {\overline{H}}_{j}^{H} + E ( {H}_{w} ( {\sum }_{i = 1}^{K} {T}_{i} {T}_{i}^{H} ) {H}_{w}^{H} + 2 I - {T}_{j}^{H} {\overline{H}}_{j}^{H} - {\overline{H}}_{j} {T}_{j} ) . \qquad ( 37 )$$

The second term on the RHS expansion can be simplified to

$$E ( {H}_{w} ( {\sum }_{i = 1}^{K} {T}_{i} {T}_{i}^{H} ) {H}_{w}^{H} ) = E [ {H}_{w} {H}_{w}^{H} tr ( {\sum }_{i = 1}^{K} {T}_{i} {T}_{i}^{H} ) ] = {R}_{i} tr ( {\sum }_{i = 1}^{K} {T}_{i} {T}_{i}^{H} ) . \qquad ( 38 )$$

After writing the Lagrangian, and taking the derivative with respect to T*ⱼ, we obtain

$$( {\sum }_{i = 1}^{K} {\overline{H}}_{i}^{H} {\overline{H}}_{i} + λ I + {R}_{t} ) {T}_{j} = {\overline{H}}_{j}^{H} , \qquad ( 39 )$$

by which we obtain the filter

$${T}_{j} = {( {\sum }_{i = 1}^{K} {\overline{H}}_{i}^{H} {\overline{H}}_{i} + λ I + {R}_{i} )}^{- 1} {\overline{H}}_{j}^{H} . \qquad ( 40 )$$

To satisfy the power constraint, we can show that λ is the solution of the equation

$$P = \sum \frac{{γ}_{j}}{{( {γ}_{j} + λ )}^{2}} , \qquad ( 41 )$$

where γⱼ are the eigenvalues of the Hermitian matrix. The same result could be extended to the asymmetric case,

### Effect of the Invention

An adaptive beamforming method maximizes an upper bound on the total network throughput by selecting optimal, transmission rates and cooperation architectures during different phases of transmission. The method increases the total network: throughput compared to conventional non cooperative schemes.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit: and scope of the invention.

We claim:

1. A method for transmitting data from a base station, via relay stations, to user stations in a wireless cooperative relay network, comprising:
acquiring imperfect channel state information (CSI) for downlink channels from the base station and the relay stations to the user stations;
determining, for each candidate transmission strategy of a set of candidate transmission strategies, a corresponding beam forming matrix according the imperfect CSI;
determining, for each beamforming matrix, a bound on an expected target benefit function;
selecting a particular one of the bounds; and
transmitting the data from the base station, via the relay stations, to the user stations according to the beamforming matrix and candidate strategy associated with the selected bound.

2. The method of claim 1, in which the network is designed according to a WiMAX standard.

3. The method, of claim 1, in which the base station transmits the data to the relay stations during a first phase using time division multiple access, and the relay stations transmit the data to the user stations during a second phase using joint beamforming.

4. The method of claim 1, in which the imperfect CSI is in a form of a mean and covariance of the CSI.

5. The method of claim 1, further comprising:
applying linear preceding to the data at the relay stations.

6. The method of claim 1, in which the expected target benefit function is defined as a ratio of a total number of bits transmitted for the data to a total time for transmitting the bits.

7. The method of claim L where the target benefit function is an expected system throughput.

8. The method of claim 1, in which the bound is an upper bound, and the selected bound is a maximum bound.

9. The method of claim 1, in which the bound is a lower bound, and the selected bound is a maximum bound.

10. The method of claim 1, in which the bound is an approximation.

11. The method of claim 1, in which the set of candidate transmission strategies include single user messaging, dual messaging, asymmetric message knowledge, and symmetric knowledge.

12. The method of claim 1, further comprising:
maximizing the upper bound for a total mean network throughput using channel mean and covariance information.

13. The method of claim 1, further comprising:
maximizing the upper bound on a sum rate of transmission during the second phase.

14. The method of claim 11, further comprising:
providing partial zero forcing and minimum mean square error beamforming filters in case of the asymmetric message knowledge.

15. The method of claim 3, in which, the beamforming uses symmetric linear preceding.

16. The method of claim 3, in which the beamforming uses asymmetric linear preceding.

17. The method of claim 1, in which one entry of a particular beamforming vector in the beamforming matrix is forced to zero, and further comprising:
optimizing non-zero beamforming vectors to maximize a sum rate of the transmitting from the relay stations to the user stations.

18. The method of claim 3, in which the beamforming minimizes a sum of a mean square error between transmitted and received signals.

19. A system for transmitting data from a base station, via relay stations, to user stations in a wireless cooperative relay network, comprising:
means for acquiring imperfect channel state information (CSI) for downlink channels from the base station and the relay stations to the user stations;
means for determining, for each candidate transmission strategy of a set of candidate transmission strategies, a corresponding beamforming matrix according the imperfect CSI:
means for determining, for each beamforming matrix, a bound on an expected target benefit function;
means for selecting a particular one of the bounds; and
means for transmitting the data from the base station, via the relay stations, to the user stations according to the beamforming matrix and candidate strategy associated with the selected bound.

20. A wireless cooperative relay network, comprising:
a base station;
a plurality of relay stations;
a plurality of user stations, in which the base station and the plurality of relay stations acquire imperfect channel state information (CSI) for downlink channels from the base station and the plurality of relay stations to the plurality of user stations;
means for determining, for each candidate transmission strategy of a set of candidate transmission strategies, a corresponding beamforming matrix according the imperfect CSI;
means for determining, for each beamforming matrix, a bound on an expected target benefit function;
means for selecting a particular one of the bounds; and
means for transmitting the data from the base station, via the relay stations, to the user stations according to the beamforming matrix and candidate strategy associated with the selected bound.
